(19) United States
(12) Patent Application Publication
(10) Pub. No.: US 2016/0083531 A1
(43) Pub. Date: Mar. 24, 2016

(54) FUNCTIONALIZED DIENE RUBBERS

(71) Applicant: LANXESS Deutschland GmbH, Cologne (DE)

(72) Inventors: Norbert STEINHAUSER, Dormagen (DE); Thomas GROSS, Wuelfrath (DE)

(21) Appl. No.: 14/956,679

(22) Filed: Dec. 2, 2015

Related U.S. Application Data
(62) Division of application No. 13/123,995, filed on Aug. 4, 2011, now abandoned.

(30) Foreign Application Priority Data
Oct. 16, 2008 (DE) 10 2008 052 057.8

(51) Int. Cl. C08J 3/24; C08K 3/36; C08K 3/04; C08K 5/18

(52) U.S. Cl. CPC C08J 3/24; C08K 5/18; C08K 3/36; C08K 3/04; C08J 2309/06; C08K 2003/045

(57) ABSTRACT

The present invention relates to functionalised diene rubbers and their production, to rubber mixtures, comprising these functionalised diene rubbers, and to their use for the production of rubber vulcanisates, which serve in particular for the production of highly reinforced rubber mouldings. Particular preference is given to the use in the production of tyres which have particularly low rolling resistance, and particularly high wet slip resistance and abrasion resistance.

This application is a divisional of pending U.S. patent application Ser. No. 13/123,995 filed Aug. 4, 2011, with the same title, which claims the right of priority under 35 U.S.C. §119 (a)-(d) and 35 U.S.C. §365 of International Application No. PCT/EP2009/063451, filed Oct. 15, 2009, which is entitled to the right of priority of German Patent Application No. 10 2008 052 057.8, filed Oct. 16, 2008, the contents of which are hereby incorporated by reference in their entirety.

The present invention relates to functionalised diene rubbers and their production, to rubber mixtures, comprising these functionalised diene rubbers, and to their use for the production of rubber vulcanisates, which serve in particular for the production of highly reinforced rubber mouldings. Particular preference is given to the use in the production of tyres which have particularly low rolling resistance, and particularly high wet slip resistance and abrasion resistance.

An important property desired in tyres is good adhesion to dry and wet surfaces. It is very difficult here to improve the slip resistance of a tyre without a simultaneous increase in rolling resistance and abrasion. Low rolling resistance is significant for low fuel consumption, and high abrasion resistance is the decisive factor for long tyre lifetime.

Wet slip resistance, rolling resistance and abrasion resistance of a tyre depend largely on the dynamic mechanical properties of the rubbers used to construct the tyre. In order to lower roiling resistance, rubbers with high rebound resilience are used for the tyre tread. On the other hand, rubbers with a high damping factor are advantageous for improving wet slip resistance. In order to find a compromise between these contradictory dynamic mechanical properties, mixtures composed of various rubbers are used in the tread. The usual method uses a mixture composed of one or more rubbers with relatively high glass transition temperature, e.g., styrene-butadiene rubber, and of one or more rubbers with relatively low glass transition temperature, e.g. polybutadiene with low vinyl content.

Anionically polymerised solution rubbers containing double bonds, e.g., solution polybutadiene and solution styrene-butadiene rubbers, have advantages over corresponding emulsion rubbers for the production of low-rolling-resistance tyre treads. The advantages lie inter alia in the controllability of vinyl content and of the associated glass transition temperature and molecular branching, The result of this in practical applications is particular advantages in the relationship of wet slip resistance and rolling resistance of the tyre. By way of example U.S. Pat. No. 5,227,425 describes the production of tyre treads from a solution SBR and silica. Numerous methods of end-group modification have been developed to provide a further improvement in properties, for example as described in EP-A 334 042 using dimethylaminopropylacrylamide, or as described in EPA 447 066 using silyl ethers. However, because of the high molecular weight of the rubbers, the proportion by weight of the end groups is small, and these can therefore have only a small effect on the interaction between filler and rubber molecule. U.S. 2005/0 256 284 A1 describes copolymers composed of diene and of functionalised vinylaromatic monomers. The disadvantage of these copolymers, produced by means of anionic polymerisation, lies in the complicated synthesis of the functionalised vinylaromatic monomers and in the severe restriction of the choice of functional groups, since the only functional groups that can be used are those which do not react with the initiator during the anionic polymerisation reaction. It is therefore in particular not possible to use functional groups which have hydrogen atoms which are capable of forming hydrogen bonds and which are therefore capable of particularly advantageous interactions with polar groups at the surface of the added filler, e.g. carbon black or silica.

In the light of the abovementioned restrictions, it is therefore more preferable to functionalise the main chain of the polymer, in a reaction downstream of the polymerisation reaction. The degree of functionalisation that can be achieved by this method is higher than with end-group modification. It is also possible to introduce functional groups which can form hydrogen bonds, e.g. hydroxy groups. Functional groups of this type have particularly advantageous interactions with the polar groups at the surface of the added filler.

The literature here discloses hydroxy functional diene rubbers in which the linkage of the functionalising reagent containing hydroxy groups to the main chain of the polymer takes place by way of a sulphur bridge. By way of example, in EP 0974616 A1 or DE 2653144 A1 the polymerisation reaction and subsequent reaction with hydroxymercaptans and/or with mercaptocarboxylic esters containing hydroxy groups takes place in solution. The difunctional (one OH- and one SH-functionality) hydroxymercaptans particularly highlighted in the examples have the disadvantage of high volatility, the result being unpleasant odour during work-up. According to EP 0464 478 A1, this is avoided by using relatively long-chain difunctional hydroxymercaptans. However, the reaction does not then take place in solution, but within the solid rubber, and this requires a complicated kneading procedure. Furthermore, the only hydroxymercaptans used are those having secondary hydroxy group, which have less activity in relation to interaction with the filler subsequently added within the compounded material.

It was therefore an object to provide functionalised diene rubbers which do not have the disadvantages of the prior art, e.g. high volatility of the functionalising reagent, complicated production within the solid rubber, and poor interaction with respect to the filler.

Surprisingly, it has now been found that the functionalised diene rubbers according to the invention, produced using a functionalising reagent composed of one mercapto functionality and of 2 hydroxy functionalities (trifunctionality) do not have the disadvantages of the prior art.

The present invention therefore provides novel functionalised diene rubbers, obtained via the polymerisation of dienes and, if appropriate, of vinylaromatic monomers in a solvent and subsequent reaction with hydroxymercaptans of the formula:

HS—R—OH,

in which

R is a linear, branched or cyclic C₁-C₃₆-alkylene or -alkenylene group or an aryl group, where each of these groups has a further hydroxy group as substituent, and, if appropriate, can have interruption by nitrogen, oxygen or sulphur atoms and, if appropriate, has aryl substituents.

The average molar masses (number average) of the diene rubbers according to the invention are from 50000 to 2000000 g/mol, preferably from 100000 to 1000000 g/mol, and their Mooney viscosities ML 1+4 (100° C.) are preferably from 10 to 200 Mooney units, preferably from 30 to 150 Mooney units.

Dienes used are preferably 1,3-butadiene, isoprene, 1,3-pentadiene, 2,3-dimethylbutadiene, 1-phenyl-1,3-butadiene and/or 1,3-hexadiene. It is particularly preferable to use 1,3-butadiene and/or isoprene,

Examples that may be mentioned of vinylaromatic monomers that can be used for the polymerisation reaction are styrene, o-, m- and/or p-methylstyrene, p-tert-butylstyrene, α-methylstyrene, vinylnaphthalene, divinylbenzene, trivinylbenzene and/or divinylnaphthalene. It is particularly preferable to use styrene.

In one particularly preferred embodiment of the invention, the diene is 1,3-butadiene and the vinylaromatic monomer is styrene.

In one preferred embodiment of the invention, the content of copolymerised vinylaromatic monomers in the functionalised diene rubbers is from 0 to 60% by weight, preferably from 15 to 45% by weight, and their content of dienes is from 40 to 100% by weight, preferably from 55 to 85% by weight, where the content of 1,2-bonded dies es (vinyl content) in the dienes is from 0.5 to 95% by weight, preferably from 10 to 85% by weight, and the entirety composed of copolymerized vinylaromatic monomers and dienes gives a total of 100%, and the said rubber comprises from 0.02 to 20 parts by weight, preferably from 0.1 to 5 parts by weight, of chemically bonded hydroxymercaptan, based on 100 parts by weight of diene rubber.

Preferred hydroxymercaptans are 3-mercaptopropane-1,2-diol, 2-mercaptopropane-1,3-diol, 3-mercapto-2-methylpropane-1,2-diol, 2-mercapto-2-methylpropane-1₉3diol, 4-mercaptobutane-1,2-4-mercaptobutane-1,3-diol, 1,3-mercaptomethyl-2-methylpropane-1,3-diol, 5-mercaptopentane-1,2-diol, 5-mercaptopentane-1,3-diol, 4-mercapto-3-methylbutane-1,2-diol, 4-mercapto-3-methylbutane-1,3-diol, 3-mercaptocyclopentane-1,2-diol, 2-mercaptocyclopentane-1,3-diol, 4-mercaptocyclopentane-1,2-diol, 4-mercaptocyclopentane-1,3-diol, 2-mercapto-4-cyclopentene-1,3-diol, 3-mercapto-4-cyclopentene-1,2-diol, 3-mercaplocyclohexane-1,2-diol, 4-mercaptocyclohexane-1,2-diol, 4-mercaptocyclohexane-1,3-diol, 5-mercaptocyclohexane-1,3-diol, 2-mercaptocyclohexane-1,4-diol, 2,5-dihydroxythiophenol, 2,6-dihydroxythiophenol, 2,4-dihydroxythiophenol, 3,5-dihydroxythiophenol, 2,3-dihydroxythiophenol, 3,4-dihydroxythiophenol. Particular preference is given to 3-mercaptopropane-1,2-diol.

The functionalised diene rubbers according to the invention, having a polymer chain composed of repeat units based on at least one of the abovementioned dienes, and optionally having one or more of the abovementioned vinylaromatic monomers, accordingly have functional groups of the formula —S—R—OH along the polymer chain, where R is as defined above.

Preferred solvents for the functionalisation reaction for the purposes of the invention are hydrocarbons or a mixture of these. Particular preference is given to inert aprotic solvents, e.g. paraffinic hydrocarbons, such as isomeric pentanes, hexanes, heptanes, octanes, decanes, cyclopentane, cyclohexane, methylcyclohexane, ethylcyclohexane or 1,4-dimethylcyclohexane or aromatic hydrocarbons, such as benzene, toluene, ethylbenzene, xylene, diethylbenzene or propylbenzene. Preference is given to cyclohexane and n-hexane. Blending with polar solvents is also possible.

The amount of solvent is usually from 100 to 1000 g, preferably from 200 to 700 g, based on 100 g of the entire amount of rubber used.

The invention also provides a process for the production of the rubbers according to the invention in that dienes and, if appropriate, vinylaromatic monomers are polymerised in a solvent and then are reacted, at temperatures of from 50 to 180° C. in the presence of free-radical initiators, with at least one hydroxymercaptan of the formula:

HS—R—OH,

in which

R is a linear, branched or cyclic C₁-C₃₆-alkylene or alkenylene group or an aryl group, where each of these groups has a further hydroxy group as substituent, and, if appropriate, can have interruption by nitrogen, oxygen or sulphur atoms and, if appropriate, has aryl substituents.

The rubbers according to the invention for the rubber mixtures according to the invention are preferably produced via anionic solution polymerization or via polymerization by means of coordination catalysts. Coordination catalysts in this context are Ziegler-Natta catalysts or monometallic catalyst systems. Preferred coordination catalysts are those based on Ni, Co, Ti, Nd, V, Cr or Fe.

Initiators for the anionic solution polymerization reaction are those based on alkali metal or on alkaline earth metal, an example being n-butyllithium. It is also possible to use the known randomizers and control agents for the microstructure of the polymer, examples being potassium tert-amyl alcoholate, sodium tert-amyl alcoholate and tert-butoxyethoxyethane. Solution polymerization reactions of this type are known and are described by way of example in I. Franta, Elastomers and Rubber Compounding Materials, Elsevier 1989, pages 113-131, and in Comprehensive Polymer Science, Vol. 4, Part II (Pergamon Press Ltd., Oxford 1989), pages 53-108.

The solvent used preferably comprises the solvent or solvent mixture corresponding to the functionalisation solvent described above.

The amount of solvent in the process according to the invention is usually from 100 to 1000 g, preferably from 200 to 700 g, based on 100 g of the entire amount of monomer used. However, it is also possible to polymerize the monomers used in the absence of solvents.

The polymerization temperature can vary widely and is generally in the range from 0° C. to 200° C., preferably from 40° C. to 130° C. The reaction time likewise varies widely from a few minutes to a few hours. The polymerization reaction is usually carried out within a period of from about 30 minutes to 8 hours, preferably from 1 to 4 hours, It can be carried out either at atmospheric pressure or at an elevated pressure (from 1 to 10 bar).

The reaction with the hydroxymercaptans is generally carried out at temperatures of from 50 to 180° C., preferably at from 70 to 130° C., in the presence of free-radical initiators.

For the purposes of the invention, examples of free-radical initiators are peroxides, in particular acyl peroxides, such as dilauroyl peroxide and dibenzoyl peroxide, and ketal peroxides, such as 1,1-di(tert-butylperoxy)-3,3,5-trimethylcyclohexane, and also azo initiators, such as azobisisobutyronitrile, or benzopinacol silyl ethers, or the reaction can be carried out in the presence of photo initiators and of visible or UV light.

The amount of hydroxymercaptans to be used depends on the desired content of bonded hydroxy groups in the diene rubber according to the invention. It is preferably from 0.1 to 5 g of hydroxymercaptan, based on 100 g diene rubber.

The present invention also provides rubber mixtures, comprising the diene rubbers according to the invention and also from 10 to 500 parts by weight of filler, based on 100 parts by weight of diem rubber.

Fillers that can be used for the rubber mixtures according to the invention comprise all the known fillers used in the rubber industry. These encompass not only active fillers but also inert fillers.

Examples that may be mentioned are:
fine-particle silicas, produced by way of example via precipitation from solutions of silicates, or flame hydrolysis of silicon halides with specific surface areas of from 5 to 1000 m²/g (BET surface area), preferably from 20 to 400 m²/g, and with primary particle sizes of from 10 to 400 nm. The silicas can, if appropriate, also take the form of mixed oxides with other metal oxides, such as oxides of Al, of Mg, of Ca, of Ba, of Zn, of Zr, or of Ti;
synthetic silicates, such as aluminium silicate, or alkaline earth metal silicate, e.g. magnesium silicate or calcium silicate, with BET surface areas of from 20 to 400 m²/g and with primary particle diameters of from 10 to 400 nm;
natural silicates, such as kaolin and any other naturally occurring form of silica;
glass fibres and glass-fibre products (mats, strands), or glass microbeads;
metal oxides, such as zinc oxide, calcium oxide, magnesium oxide, or aluminium oxide;
metal carbonates, such as magnesium carbonate, calcium carbonate, or zinc carbonate;
metal hydroxides, e.g. aluminium hydroxide or magnesium hydroxide;
carbon blacks prepared by the flame-black process, channel-black process, furnace-black process, gas-black process, thermal-black process, acetylene-black process or arc process, their BET surface areas being from 9 to 200 m²/g, e.g, super abrasion furnace (SAF), intermediate SAF, intermediate SAF low structure (ISAF-LS), intermediate SAF high modulus (ISAF-HM), intermediate SAF low modulus (ISAF-LM), intermediate SAF high structure (ISAF-HS), conductive furnace (CF), super conductive furnace (SCF), high abrasion furnace (HAF), high abrasion furnace low structure (HAF-LS), HAF-HS, fine furnace high structure (FF-HS), semi reinforcing furnace (SRF), extra conductive furnace (XCF), fast extruding furnace (FEF), fast extruding furnace low structure (FEF-LS), fast extruding furnace high structure (FEF-HS), general purpose furnace (GPF), GPF-HS, all purpose furnace (APF), SRF-LS, SRF-LM, SRF-HS, SRF-HM and medium thermal (MT) carbon blacks, or the following types according to ASTM classification: NI 10, N219, N220, N231, N234, N242, N294, N326, N327, N330, N332, N339, N347, N351, N356, N358, N375, N472, N539, N550, N568, N650, N660, N754, N762, N765, N774, N787 and N990 carbon blacks;
rubber gels, in particular those based on polybutadiene, butadiene-styrene copolymers, butadiene-acrylonitrile copolymers and polychloroprene.

Fillers preferably used are fine-particle silicas and/or carbon blacks.

The fillers mentioned can be used alone or in a mixture. In one particularly preferred embodiment, the rubbers comprise, as further filler constituents, a mixture composed of pale-coloured fillers, such as fine-particle silicas, and of carbon blacks, where the mixing ratio of pale-coloured fillers to carbon blacks is from 0.05:1 to 20:1, preferably from 0.1:1 to 15:1.

The amounts used here of the fillers are in the range from 10 to 500 parts by weight of filler, based on 100 parts by weight of rubber. It is preferable to use from 20 to 200 parts by weight.

The rubber mixtures of the invention can comprise not only the functionalised diene rubber mentioned but also other rubbers, such as natural rubber, or else other synthetic rubbers. The amount of these is usually in the range from 0.5 to 85% by weight, preferably from 10 to 70% by weight, based on the entire amount of rubber in the rubber mixture. The amount of additionally added rubbers depends again on the respective intended use of the rubber mixtures of the invention.

Examples of additional rubbers are natural rubber, and also synthetic rubber.

Synthetic rubbers known from the literature are listed here by way of example. They encompass inter alia
BR—Polybutadiene
ABR—Butadiene-C₁₋₄-alkyl acrylate copolymers
CR—Polychloroprene
IR—Polyisoprene
SBR—Styrene-butadiene copolymers having styrene contents of from 1 to 60% by weight, preferably from 20 to 50% by weight,
IIR—Isobutylene-isoprene copolymers
NBR—Butadiene-acrylonitrile copolymers having acrylonitrile contents of from 5 to 60% by weight, preferably from 10 to 40% by weight
HNBR—partially hydrogenated or fully hydrogenated NBR rubber
EPDM—ethylene-propylene-diene terpolymers

and also mixtures of these rubbers. Materials of interest for the production of motor vehicle tyres are more particularly natural rubber, emulsion SBR, and also solution SHR, with glass transition temperature above −50° C., polybutadiene rubber with high cis content (>90%), produced using catalysts based on Ni. Co, Ti or Nd, and also polybutadiene rubber having vinyl content of up to 85%, and also mixtures of these,

The rubber mixtures according to the invention can, of course, comprise rubber auxiliaries which by way of example serve for the crosslinking of the rubber mixtures (crosslinking agents), or serve for coupling of the rubber to the filler, or bring about better dispersion of the filler, or improve the chemical and/or physical properties of the vulcanisates produced from the rubber mixtures according to the invention, for the specific intended purpose of these.

Crosslinking agents used are particularly sulphur or sulphur-donor compounds. It is also possible, as mentioned, that the rubber mixtures according to the invention comprise further auxiliaries, such as the known reaction accelerators, antioxidants, heat stabilisers, light stabilisers, antiozononts, processing aids, plasticizers, tackifiers, blowing agents, dyes, pigments, waxes, extenders organic acids, retarders, metal oxides, silanes, and also activators.

To the extent that the rubber mixtures according to the invention also comprise fillers, oils and/or further auxiliaries, these can by way of example be produced via blending in or on suitable mixing apparatuses, such as kneaders, rolls or extruders.

The method of production of the rubber mixtures according to the invention is preferably such that the polymerization of the monomers is first undertaken in solution, and the functional groups are introduced into the diene rubber, and after completion of the polymerization reaction and introduction of the functional groups, the diene rubber according to the invention, present in the appropriate solvent, is mixed with antioxidants and, if appropriate, process oil, filler, further rubbers, and further rubber auxiliaries, in the appropriate amounts, and, during or after the mixing procedure, the solvent is removed using hot water and/or steam, at temperatures of from 50° C. to 200° C., if appropriate in vacuo.

Process oils used preferably comprise DAE (distillate aromatic extract) oil, TDAE (treated distillate aromatic extract) oil, MES (mild extraction solvates) oil, RAE (residual aromatic extract) oil, TRAE (treated residual aromatic extract) oil, and naphthenic and heavy naphthenic oils.

In a further embodiment of the process according to the invention, the dienes and the vinylaromatic polymers are polymerized in solution to give rubber, and then the functional groups are introduced into the diene rubber, and then the solvent-containing rubber is mixed with antioxidants and process oil, and, during or after the mixing procedure, the solvent is removed using hot water and/or steam, at temperatures of from 50 to 200° C., if appropriate in vacuo. In a further embodiment of the invention, following the functionalisation reaction, filler and/or process oil and, if appropriate, further rubbers and rubber auxiliaries are added.

In a further embodiment of the invention, the filler is added with the process oil after introduction of the functional groups.

The present invention further provides the use of the rubber mixtures according to the invention for the production of vulcanisates, which in turn serve for the production of highly reinforced rubber mouldings, in particular for the production of tyres.

The examples below serve to illustrate the invention, but without any resultant limiting effect.

### EXAMPLES

### Example 1

### Synthesis of Styrene-Butadiene Rubber and Functionalisation Using 3-Mercaptopropane-1,2-Diol (According to the Invention)

The following were initially charged with stirring to a dried and nitrogen-blanketed 2 L steel reactor: 850 g of hexane, 0.11 mmol of potassium tert-amyl alcoholate (in the form of 14.9% strength solution in cyclohexane), 13.5 mmol of vert-butoxyethoxyethane, 37.5 g of styrene, 112.5 g of 1,3-butadiene, and 1.5 mmol of butyllithium (in the form of 23% strength solution in hexane). The mixture was heated to 70° C. for 1 h, with stirring. After addition of 0.77 g of 3-mercaptopropane-1,2-diol, a specimen was immediately taken for mercaptotitration. The mixture was then heated to 110° C., and 1 mL of 1,1-di(tert-butylperoxy)-3,3,5-trimethylcyclohexane (in the form of 5% strength solution) was added. After 90 minutes, a specimen was again taken for mercaptotitration, and then the reactor contents were precipitated in ethanol and stabilised using BHT. The rubber was isolated from the ethanol and dried at 60° C. in vacuo for 16 h.

### Analysis Results:

Conversion based on hydroxyrnercaptan (potentiometric titration using ethanolic AgNO₃ solution): 77%

Mooney viscosity (ML 1+4 at 100° C.): 72 Mooney units

Vinyl content (by IR spectroscopy): 51% by weight

Styrene content (by IR spectroscopy): 25% by weight

Example 1 shows that it is possible to use reaction of a diene rubber with 3-mercaptopropane-1,2-diol in solution as a simple method of producing a hydroxy-functionalised diene rubber according to the invention. No unpleasant odour from unreacted hydroxymercaptan can be discerned from the functionalised diene rubber according to the invention.

### Example 2a

### Synthesis of Styrene-Butadiene Rubber and Functionalisation Using 3-Mercaptopropane-1,2-Diol (According to the Invention)

The following were initially charged with stirring to a dried and nitrogen-blanketed 20 L steel reactor. 8.5 kg of hexane, 1.2 mmol of potassium tent-amyl alcoholate (in the form of 14.9% strength solution in cyclohexane), 91.2 mmol of tort-butoxyethoxyethane, 375 g of styrene, 1125 g of1,3-butadiene, and 18.8 mmol of butyllithium (in the form of 23% strength solution in hexane). The mixture was heated to 70° C. for 1 h, with stirring. After addition of 10.7 g (98 mmol) of 3-mercaptopropane-1,2-diol, a specimen was immediately taken for mercaptotitration. The mixture was then heated to 115° C., and 1.45 mL of 1,1-di(tert-butylperoxy)-3,3,5-trimethylcyclohexane (in the form of 50% strength solution) was added. After 90 minutes, a specimen was again taken for mercaptotitration, and then the reactor contents were discharged and stabilised using 3 g of 2,4-bis(octylthiomethyl)-6-methylphenol (Irganox 1520 from Cilia). During discharge of the rubber solution, there was no unpleasant odour from unreacted 3-mercaptopropane-1,2-diol. The rubber was isolated from the solvent by using steam to strip the rubber solution. The rubber crumb was finally dried for 16 hours at 60° C. in a vacuum oven.

### Analysis Results:

Conversion based on 3-mercaptopropane-1, 2-diol (potentiometric titration using ethanolic AgNO₃ solution): 89%
Mooney viscosity (ML1+4 at 100° C.): 67 Mooney units
Vinyl content (by IR spectroscopy): 50% by weight
Styrene content (by IR spectroscopy): 25% by weight

### Example 2b

### Synthesis of Styrene-Butadiene Rubber and Functionalisation Using 3-Mercaptopropane-1,2-Diol (According to the Invention)

The following were initially charged with stirring to a dried and nitrogen-blanketed 20 L steel reactor: 8.5 kg of hexane, 1.2 mmol of potassium tent-amyl alcoholate (in the form of 14.9% strength solution in cyclohexane), 91.2 mmol of tort-butoxyethoxyethane, 375 g of styrene, 1125 g of 1,3-butadiene, and 17.6 mmol of butyllithium (in the form of 23% strength solution in hexane). The mixture was heated to 70° C. for 1 h, with stirring. After addition of 5.2 g (48 mmol) of 3-mercaptopropane4,2-diol, a specimen was immediately taken for mercaptotitration. The mixture was then heated to 115° C., and 1.45 mL of 1,1-di(tert-butylperoxy)-3,3,5-trimethylcyclohexane (in the form of 50% strength solution) was added. After 90 minutes, a specimen was again taken for mercaptotitration, and then the reactor contents were discharged and stabilised using 3 g of 2,4-bis(octylthiomethyl)-6-methylphenal (Irganox 1520 from Ciba). During discharge of the rubber solution, there was no unpleasant odour from unreacted 3-mercaptopropane-1,2-diol. The rubber was isolated from the solvent by using steam to strip the rubber solution. The rubber crumb was finally dried for 16 hours at 60° C. in a vacuum oven.

### Analysis Results:

Conversion based on 3-mercaptopropane-1, 2-diol (potentiometric titration using ethanolic AgNO₃ solution): 80%
Mooney viscosity (ML1+4 at 100° C.): 74 Mooney units
Vinyl content (by IR spectroscopy): 50% by weight
Styrene content (by IR spectroscopy): 25% by weight

### Example 2c

### Synthesis of Styrene-Butadiene Rubber and Functionalisation Using 3-Mercaptopropane-1,2-Diol (According to the Invention)

The following were initially charged with stirring to a dried and nitrogen-blanketed 20 L steel reactor: 8.5 kg of hexane, 1.2 mmol of potassium tert-arnyl alcoholate (in the form of 14.9% strength solution in cyclohexane), 91.2 mmol of tert-butoxyethoxyethane, 375 g of styrene, 1125 g of 1,3-butadiene, and 17.6 mmol of butyllithium (in the form of 23% strength solution in hexane). The mixture was heated to 70° C. for 1 h, with stirring. After addition of 20.6 g (189 mmol) of 3-mercaptopropane-1,2-diol, a specimen was immediately taken for mercaptotitration. The mixture was then heated to 115° C., and 1.45 mL of 1,1-di(tert-butylperoxy)-3,3,5-trimethylcyclohexane (in the form of 50% strength solution) was added. After 90 minutes, a specimen was again taken for mercaptotitration, and then the reactor contents were discharged and stabilised using 3 g of 2,4-bis(octylthiomethyl)-6-methylphenol (Irganox 1520 from Ciba). During discharge of the rubber solution, there was no unpleasant odour from unreacted 3-mercaptopropane-1,2-diol. The rubber was isolated from the solvent by using steam to strip the rubber solution. The rubber crumb was finally dried for 16 hours at 60° C. in a vacuum oven.

### Analysis Results:

Conversion based on 3-mercaptopropane-1, 2-diol (potentiometric titration using ethanolic AgNO₃ solution): 80%
Mooney viscosity (ML1+4 at 100° C.): 72 Mooney units
Vinyl content (by IR spectroscopy): 50% by weight
Styrene content (by IR spectroscopy): 25% by weight

### Example 2d

### Synthesis of Styrene-Butadiene Rubber and Functionalisation Using 2-Mercaptoethanol (Comparison)

The following were initially charged with stirring to a dried and nitrogen-blanketed 20 L steel reactor: 8.5 kg of hexane, 1.2 mmol of potassium tert-amyl alcoholate (in the form of 14.9% strength solution in cyclohexane), 91.2 mmol of tent-butoxyethoxyethane, 375 g of styrene, 1125 g of 1,3-butadiene, and 17.6 mmol of butyllithium (in the form of 23% strength solution in hexane). The mixture was heated to 70° C. for 1 h, with stirring. After addition of 7.7 g (99 mmol) of 2-mercaptoethanol, a specimen was immediately taken for mercaptotitration. The mixture was then heated to 115° C., and 1.45 of 1,1-di(tert-butylperoxy)-3,3,5-trimethylcyclohexane (in the form of 50% strength solution) was added. After 90 minutes, a specimen was again taken for mercaptotitration, and then the reactor contents were discharged and stabilised using 3 g of 2,4-bis(octylthiomethyl)-6-methylphenol (Irganox 1520 from Ciba). During discharge of the rubber solution, there was a marked unpleasant odour from unreacted 2-mercaptoethanol. The rubber was isolated from the solvent by using steam to strip the rubber solution. The rubber crumb was finally dried for 16 hours at 60° C. in a vacuum oven.

### Analysis Results:

Conversion based on 2-mercaptoethanol (potentiometric titration using ethanolic AgNO₃ solution): 80%
Mooney viscosity (ML1+4 at 100° C.): 73 Mooney units
Vinyl content (by IR spectroscopy): 50% by weight
Styrene content (by IR spectroscopy): 25% by weight

### Example 2e

### Synthesis of Styrene-Butadiene Rubber and Functionalisation Using 2-Mercaptoethanol (Comparison)

The following were initially charged with stirring to a dried and nitrogen-blanketed 20 L steel reactor: 8.5 kg of hexane, 1.2 mmol of potassium tent-amyl alcoholate (in the form of 14.9% strength solution in cyclohexane), 91.2 mmol of tert-butoxyethoxyethane, 375 g of styrene, 1125 g of 1, 3-butadiene, and 17.6 mmol of butyllithium (in the form of 23% strength solution in hexane). The mixture was heated to 70° C. for 1 h, with stirring, After addition of 15.9 g (204 mmol) of 2-mercaptoethanol, a specimen was immediately taken for mercaptotitration. The mixture was then heated to 115° C., and 1.45 mL of 1,1-di(tert-butylperoxy)-3,3,5-trimethylcyclohexane (in the form of 50% strength solution) was added. After 90 minutes, a specimen was again taken for mercaptotitration, and then the reactor contents were discharged and stabilised using 3 g of 2,4-bis(octylthiomethyl)-6-methylphenol (Irganox 1520 from Ciba). During discharge of the rubber solution, there was a marked unpleasant odour from unreacted 2-mercaptoethanol. The rubber was isolated from the solvent by using steam to strip the rubber solution. The rubber crumb was finally dried for 16 hours at 50° C. in a vacuum oven.

### Analysis Results:

Conversion based on mercaptoethanol (potentiometric titration using ethanolic AgNO₃ solution): 85%
Mooney viscosity (ML1+4 at 100° C.): 73 Mooney units
Vinyl content (by IR spectroscopy): 51% by weight
Styrene content (by IR spectroscopy): 25% by weight

### Example 2f

### Synthesis of Styrene-Butadiene Rubber Without Functionalisation (Comparison)

The following were initially charged with stinting to a dried and nitrogen-blanketed 20 L steel reactor: 8.5 kg of hexane, 1.2 mmol of potassium tert-amyl alcoholate (in the form of 14.9% strength solution in cyclohexane), 74.2 mmol of ten-butoxyethoxyethane, 375 g of styrene, 1125 g of 1,3-butadiene, and 16.1 mmol of butyllithium (in the form of 23% strength solution in hexane). The mixture was heated to 70° C. for 13 h, with stirring. The reactor contents were then discharged and stabilised using 3 g of 2,4-bis(octylthiomethyl)-6-methylphenol (Irganox 1520 from Ciba). The rubber was isolated from the solvent by using steam to strip the rubber solution. The rubber crumb was finally dried for 16 hours at 60′C in a vacuum oven.

### Analysis Results:

Mooney viscosity (ML1+4 at 100° C.): 72 Mooney units
Vinyl content (by IR spectroscopy): 51% by weight
Styrene content (by IR spectroscopy); 25% by weight

Examples 2a-c according to the invention show that when the functionalising reagent 3-mercaptopropane-1,2-diol is used, there is no unpleasant odour from unreacted functionalising reagent, whereas it is apparent from comparative examples 2d and 2e that when the functionalising reagent 2-mercaptoethanol is used a marked unpleasant odour can be discerned from unreacted functionalising reagent.

### Examples 3a-f

### Rubber Mixtures

Rubber mixtures were produced comprising the styrene-butadiene rubbers according to the invention of Examples 2a-c (rubber mixtures 3a-c) and also the styrene butadiene rubbers of comparative Examples 2d-f (rubber mixtures 3d-f). Table 1 lists the mixture constituents. The rubber mixtures (without sulphur, benzenethiazolesulfenamide, diphenylguanidine and sulfonamide) were mixed for a total of 6 minutes in a first mixing stage in a 1.5 L kneader, where the temperature rose from 70° C. to 150° C. within a period of 3 minutes, and the mixture was maintained at 150° C. for 3 minutes. The mixtures were then discharged, stored at room temperature for 24 hours and, in a 2^{nd} mixing stage, again heated to 150° C. for 3 minutes. The following constituents of the mixture were then admixed on a roll at from 40 to 60° C.: sulphur, benzothiazolesulfenamide, diphenylguanidine and sulphonamide.

TABLE 1
Constituents of mixtures for rubber mixtures 3a-f (data in
phr: parts by weight per 100 parts by weight of rubber)

| | Examples according to | | | | | |
|---|---|---|---|---|---|---|
| | the invention | | | Comparative examples | | |
| Starting materials in phr | 3a | 3b | 3c | 3d | 3e | 3f |
| Functionalised styrene-butadiene rubber from | 70 | 0 | 0 | 0 | 0 | 0 |
| Example 2a | | | | | | |
| Functionalised styrene-butadiene rubber from | 0 | 70 | 0 | 0 | 0 | 0 |
| Example 2b | | | | | | |
| Functionalised styrene-butadiene rubber from | 0 | 0 | 70 | 0 | 0 | 0 |
| Example 2c | | | | | | |
| Functionalised styrene-butadiene rubber from | 0 | 0 | 0 | 70 | 0 | 0 |
| Example 2d | | | | | | |
| Functionalised styrene-butadiene rubber from | 0 | 0 | 0 | 0 | 70 | 0 |
| Example 2e | | | | | | |
| Nonfunctionalised styrene-butadiene rubber from | 0 | 0 | 0 | 0 | 0 | 70 |
| Example 2f | | | | | | |
| High-cis-content polybutadiene (Buna ™ CB 24, | 30 | 30 | 30 | 30 | 30 | 30 |
| Lanxess Deutschland GmbH) | | | | | | |
| Silica (ULTRASIL ® 7000 GR, Evonik) | 90 | 90 | 90 | 90 | 90 | 90 |
| Carbon black (VULCAN ® J/N 375, Cabot) | 7 | 7 | 7 | 7 | 7 | 7 |
| TDAE oil (VIVATEC 500, Hansen und Rosenthal) | 36.3 | 36.3 | 36.3 | 36.3 | 36.3 | 36.3 |
| Zinc soap (AKTIPLAST GT, RheinChemie Rheinau | 3.5 | 3.5 | 3.5 | 3.5 | 3.5 | 3.5 |
| GmbH) | | | | | | |
| Stearic acid (EDENOR C 18 98-100, Cognis | 1 | 1 | 1 | 1 | 1 | 1 |
| Deutschland GmbH) | | | | | | |
| Antioxidant (VULKANOX ® 4020/LG, Lanxess | 2 | 2 | 2 | 2 | 2 | 2 |
| Deutschland GmbH) | | | | | | |
| Antioxidant (VULKANOX ® HS/LG, Lanxess | 2 | 2 | 2 | 2 | 2 | 2 |
| Deutschland GmbH) | | | | | | |
| Zinc oxide (ZINKWEISS ROTSIEGEL, Grillo | 2 | 2 | 2 | 2 | 2 | 2 |
| Zinkoxid GmbH) | | | | | | |
| Light-stabiliser wax (ANTILUX ® 654, RheinChemie | 2 | 2 | 2 | 2 | 2 | 2 |
| Rheinau GmbH) | | | | | | |
| Silane (SI 69, Evonik) | 7.2 | 7.2 | 7.2 | 7.2 | 7.2 | 7.2 |
| Diphenylguanidine (VULKACIT ® D/C, Lanxess | 2.2 | 2.2 | 2.2 | 2.2 | 2.2 | 2.2 |
| Deutschland GmbH) | | | | | | |
| Benzothiazolesulphenamide (VULKACIT ® | 1.6 | 1.6 | 1.6 | 1.6 | 1.6 | 1.6 |
| NZ/EGC, Lanxess Deutschland GmbH) | | | | | | |
| Sulphur (MAHLSCHWEFEL 90/95 CHANCEL ®, | 1.6 | 1.6 | 1.6 | 1.6 | 1.6 | 1.6 |
| Solvay Barium Strontium) | | | | | | |
| Sulphonamide (VULKALENT ® E/C, Lanxess | 0.2 | 0.2 | 0.2 | 0.2 | 0.2 | 0.2 |
| Deutschland GmbH) | | | | | | |

The rubber mixtures 3a-f from Table 1 were vulcanised at 160° C. for 20 minutes. The values collated in Table 2 were determined on the vulcanisates 4a-f.

TABLE 2
Vulcanisate properties of rubber mixtures according to Table 1

| | According to the | | | | | |
|---|---|---|---|---|---|---|
| | invention | | | Comparison | | |
| Vulcanisate | 4a | 4b | 4e | 4d | 4e | 4f |
| Produced from rubber mixture | 3a | 3b | 3c | 3d | 3e | 3f |
| Amount of functionalising reagent for | 6.5 | 3.2 | 12.6 | 6.6 | 13.6 | — |
| production of styrene-butadiene rubbers | | | | | | |
| according to Examples 2a-f [mmol of | | | | | | |
| functionalising reagent per 100 g of rubber] | | | | | | |
| Rebound resilience at 23° C. [%] (DIN 53512) | 31.0 | 28.0 | 28.0 | 29.0 | 28.0 | 26.5 |
| Rebound resilience at 60° C. [%] (DIN 53512) | 60.0 | 55.5 | 58.5 | 55.0 | 57.0 | 52.0 |
| σ₅₀ (DIN 53504) [MPa] | 1.1 | 1.1 | 1.1 | 1.1 | 1.1 | 1.1 |
| σ₁₀₀ (DIN 53504) [MPa] | 2.0 | 2.0 | 2.2 | 1.9 | 2.0 | 1.9 |
| σ₃₀₀ (DIN 53504) [MPa] | 11.7 | 10.7 | 13.8 | 10.0 | 10.6 | 9.2 |
| Tensile strength (DIN 53504) [MPa] | 19.7 | 19.5 | 19.5 | 19.8 | 18.9 | 17.9 |
| Tensile strain at break (DIN 53504) [%] | 440 | 472 | 387 | 497 | 455 | 492 |
| Abrasion (DIN 53516) [mm³] | 76 | 85 | 75 | 88 | 86 | 96 |
| tan δ at 0° C. (dynamic damping at 10 Hz) | 0.582 | 0.530 | 0.720 | 0.414 | 0.485 | 0.355 |
| tan δ at 60° C. (dynamic damping at 10 Hz) | 0.112 | 0.108 | 0.104 | 0.119 | 0.114 | 0.115 |
| ΔG* (G* (0.5% tensile strain)-G* (15% | 0.49 | 0.76 | 0.33 | 0.83 | 0.60 | 1.79 |
| tensile strain)) [MPa] (MTS at 1 Hz, 60° C.) | | | | | | |
| tan δ maximum (MTS at 1 Hz, 60° C.) | 0.159 | 0.164 | 0.132 | 0.168 | 0.162 | 0.201 |

For tyre applications, low rolling resistance is needed, and this is obtained when the following are measured in the vulcanisate: a high value for rebound resilience at 60° C., a low tan δ value in dynamic damping at high temperature (60° C.), and, in the MTS test, low ΔG* and low tan δ maximum. As can be seen from Table 2, the vulcanisates of Examples 4a-c according to the invention feature high rebound resilience values at 60° C., low tan δ values in dynamic dampinc at 60° C. and low ΔG* values, and low tan δ maxima. The said advantages are achieved even when the amounts of functiortalising reagent are smaller than in the comparative Examples 4d and 4c.

High wet slip resistances also needed for tyre applications, and this is obtained when the vulcanisate has a high tan δ value in dynamic damping at low temperature (0° C.). As can be seen from Table 2, the vulcanisates of Examples 4a-c according to the invention feature high tan δ values in dynamic damping at 0° C.

High abrasion resistance is also needed in tyre applications. As can be seen from Table 2, the vulcanisates of Examples 4a-c according to the invention feature reduced DIN abrasion values.

The functionalised diene rubbers according to the invention therefore have the advantage of markedly less unpleasant odour during their production, and of improved dynamic mechanical properties and improved abrasion behaviour of the resultant vulcanisates.

What is claimed is:

1. A process for the production of functionalized diene rubber, the process comprising:
polymerizing monomers comprising dienes, in a solvent to produce diene polymer in the solvent; and
contacting the diene polymer in the solvent, in situ, with a free-radical initiator and at least one hydroxymercaptan comprising at least two —OH functional groups to produce hydroxyl-functionalized diene rubber.

2. The process according to claim 1, wherein the at least one hydroxymercaptan is of the formula:
HS—R—OH,
in which R is a linear, branched or cyclic C₁-C₃₆-alkylene or alkenylene group or an aryl group, and comprises at least one further hydroxyl group.

3. The process according to claim 2, wherein:
the free-radical initiator comprises at least one of:
photoinitiators and visible or UV light; and
chemical initiators selected from peroxides, azo compounds and benzopinacol silyl ethers; and
the solvent comprises at least one hydrocarbon solvent selected from paraffinic hydrocarbons and aromatic hydrocarbons.

4. The process according to claim 2, wherein the monomers comprise diene monomers and vinylaromatic monomers and the diene rubber comprises repeat units based on the diene monomers and the vinylaromatic monomers.

5. The process according to claim 4, wherein the polymerizing is at a temperature of 40° C. to 130° C. and comprises at least one of anionic solution polymerization and coordination catalyst polymerization.

6. The process according to claim 4, wherein:
the diene monomers comprise at least one of 1,3-butadiene, isoprene, 1,3-pentadiene, 2,3-dimethylbutadiene, 1-phenyl-1,3-butadiene, and 1,3-hexadiene;
the vinylaromatic monomers comprise at least one of styrene, o-methylstyrene, m-methylstyrene, p-methylstyrene, p-tert-butylstyrene, α-methylstyrene, vinylnaphthalene, divinylbenzene, trivinylbenzene and divinylnaphthalene; and
the hydroxymercaptan comprises at least one of 3-mercaptopropane-1,2-diol, 2-mercaptopropane-1,3-diol, 3-mercapto-2-methylpropane-1,2-diol, 2-mercapto-2-methylpropane-1,3-diol, 4-mercaptobutane-1,2-diol, 4-mercaptobutane-1,3-diol, 2-mercaptomethyl-2-methylpropane-1,3-diol, 5-mercaptopentane-1,2-diol, 5-mercaptopentane-1,3-diol, 4-mercapto-3-methylbutane-1,2-diol, 4-mercapto-3-methylbutane-1, 3-diol, 3-mercaptocyclopentane-1,2-diol, 2-mercaptocyclopentane-1,3-diol, 4-mecaptocyclopentane-1,2-diol, 4-mercaptocyclopentane-1, 3-diol, 2-mercapto-4-cyclopentene-1,3-diol, 3mercapto-4-cyclopentene-1,2-diol, 3-mercaptocyclohexane-1,2-diol, 4-mercaptocyclohexane-1, 2-diol, 4-mercaplocyclohexane-1, 3-diol, 5-mercaptocyclohexane-1,3-diol, 2-mercaptocyclohexane-1,4-diol, 2,5-dihydroxythiophenol, 2,6-dihydroxythiophenol, 2,4-dihydroxythiophenol, 3,5-dihydroxythiophenol, 2,3-dihydroxythiophenol, and 3,4dihydroxythiophenol.

7. The process according to claim 4, wherein:
the diene monomers are 1,3-butadiene and/or isoprene;
the vinylaromatic monomers are styrene; and
the hydroxymercaptan is 3-mercaptopropane-1,2-diol.

8. The process according to claim 1, wherein the contacting is done at a temperature of 50° C. to 180° C.

9. The process according to claim 1, wherein the contacting is done at a temperature of 70° C. to 130° C.

10. The process according to claim 1, further comprising, after functionalization with the hydroxyl groups, in situ addition of at least one of antioxidants, process oil, filler, further rubbers, and rubber auxiliaries, and during or after the addition, removing the solvent by using hot water and/or steam, at temperatures of 50° C. to 200° C., and optionally in the presence of a vacuum.

11. The process according to claim 10, wherein the functionalized diene comprises 10 to 500 parts by weight of filler, based on 100 parts by weight of the at least one functionalized diene rubbers.

12. The process according to claim 11, wherein the filler comprises fine-particle silicas and/or carbon blacks.

13. The process according to claim 1, wherein the functionalized diene rubber has an average molar mass of 50,000 to 2,000,000 g/mol, and a Mooney viscosity ML 1+4 (100° C.) of 10 to 200 Mooney units.

14. The process according to claim 1, wherein:
the monomers comprise diene monomers and vinylaromatic monomers, and the diene rubber comprises repeat units based on the diene monomers and the vinylaromatic monomers;
the solvent comprises at least one hydrocarbon solvent selected from paraffinic hydrocarbons and aromatic hydrocarbons;
the polymerizing is done at a temperature of 40° C. to 130° C.;
the at least one hydroxymercaptan is of the formula:
HS—R—OH,
in which R is a linear, branched or cyclic C₁-C₃₆-alkylene or alkenylene group, or an aryl group, and comprises at least one further hydroxyl group;
the contacting is done at a temperature of 70° C. to 130° C.; and
the process further comprises removing the solvent after the functionalization.

15. The process according to claim 3, wherein the functionalized diene rubber comprises 0.02 to 20 parts by weight of the hydroxymercaptan based on 100 parts by weight of the rubber, and has an average molar mass of 100,000 to 1,000,000 g/mol, and a Mooney viscosity ML 1+4 (100° C.) of 30 to 150 Mooney units.

16. A process for the production of hydroxyl-functionalized styrene-butadiene rubber, the process comprising:
polymerizing 1,3-butadiene monomers and styrene monomers in a hydrocarbon solvent to produce a mixture of styrene-butadiene polymer in the solvent; and
contacting the polymer in the solvent, in situ at a temperature of 50° C. to 200° C. with a free-radical initiator and at least one hydroxymercaptan of the formula:
HS—R—OH
in which R is a linear, branched or cyclic C₁-C₃₆-alkylene or alkenylene group, or an aryl group, and comprises at least one further hydroxyl group.

17. The process according to claim 14, wherein the hydroxymercaptan is 3-mercaptoprorpane-1,2-diol.
